(19) United States
(12) Patent Application Publication
(10) Pub. No.: US 2026/0321927 A1
(43) Pub. Date: Oct. 15, 2026

(54) BATTERY CELL

(71) Applicant: SK On Co., Ltd., Seoul (KR)

(72) Inventor: Jong Hun PARK, Daejeon (KR)

(21) Appl. No.: 19/647,903

(22) Filed: Apr. 15, 2026

(30) Foreign Application Priority Data
Apr. 15, 2025 (KR) 10-2025-0048818
Apr. 10, 2026 (KR) 10-2026-0065317

(51) Int. Cl. H01M 50/583; H01M 50/107; H01M 50/152; H01M 50/179; H01M 50/188; H01M 50/533; H01M 50/534; H01M 50/567; H01M 50/588; H01M 50/593

(52) U.S. Cl. CPC H01M 50/583; H01M 50/107; H01M 50/152; H01M 50/179; H01M 50/188; H01M 50/533; H01M 50/534; H01M 50/567; H01M 50/588; H01M 50/593; H01M 2200/106

(57) ABSTRACT

A battery cell includes a case accommodating an electrode assembly therein, a through-hole penetrating through one surface of the case, a terminal portion electrically connected to the electrode assembly and protruding to an outside of the case through the through-hole, and a variable resistance element accommodated in the terminal portion and having resistance that varies according to temperature.

### CROSS-REFERENCE TO RELATED PATENT APPLICATIONS

The present disclosure claims priority under 35 U.S.C. § 119 (a) to Korean patent application number 10-2025-0048818, filed on Apr. 15, 2025, and Korean patent application number 10-2026-0065317, filed on Apr. 10, 2026, the entire disclosure of which is incorporated herein by reference.

### BACKGROUND OF THE INVENTION

### 1. Field

Various embodiments of the present disclosure generally relate to a battery cell, and more particularly, to a battery cell having improved stability.

### 2. Description of the Related Art

In general, a battery cell includes a case accommodating an electrode assembly therein, and a terminal portion connected to the electrode assembly and protruding to the outside of the case. Typically, the case includes a conductive material.

When a rapid flow of current, such as a short circuit, occurs in the battery cell, the temperature of the battery cell may rise rapidly. Such a rapid increase in the temperature of the battery cell may cause a rapid increase in the internal pressure of the case, which in turn may increase the risk of explosion and ignition. Therefore, it is necessary to minimize, reduce, prevent, or mitigate the rapid flow of current that may occur in the battery cell.

### SUMMARY OF THE INVENTION

First, according to an aspect of the present disclosure, an object is to improve electrical characteristics of a battery cell.

Second, according to another aspect of the present disclosure, an object is to improve thermal characteristics of the battery cell.

Third, according to still another aspect of the present disclosure, an object is to prevent, mitigate, minimize, or reduce a rapid flow of current in the battery cell.

The present disclosure can be widely applied in the green technology fields such as electric vehicles, battery charging stations, energy storage systems (ESSs), and other technologies using batteries such as photovoltaics and wind power. Furthermore, the present disclosure may be used for eco-friendly mobility, including electric and hybrid vehicles, to reduce air pollution and greenhouse fluid emissions to prevent or mitigate climate change.

A battery cell according to the present disclosure may include a case accommodating an electrode assembly therein, a through-hole penetrating through one surface of the case, a terminal portion electrically connected to the electrode assembly and protruding to an outside of the case through the through-hole, and a variable resistance element accommodated in the terminal portion and having resistance that varies according to temperature.

In an embodiment, the variable resistance element may include a material having Positive Temperature Coefficient (PTC) characteristics at or above a first temperature.

In an embodiment, an average length of the variable resistance element along a direction parallel to an imaginary central axis passing through a center of the through-hole may be greater than or equal to 1 mm and less than or equal to 4 mm.

In an embodiment, the terminal portion may include a head portion in which an area of a cross-section of the terminal portion taken along a direction perpendicular to the central axis is greater than an area of the through-hole, a tail portion inserted into the case and contacting the case, and a body portion connecting the head portion to the tail portion along the central axis via the through-hole, wherein at least a portion of the variable resistance element is accommodated in the body portion.

In an embodiment, an average cross-sectional area of the variable resistance element, taken along the direction perpendicular to the central axis, may be greater than or equal to 50% and less than or equal to 90% of an average cross-sectional area of the body portion.

In an embodiment, a shape of a cross-section of the variable resistance element along the direction perpendicular to the central axis may be a polygon.

In an embodiment, a shape of a cross-section of the variable resistance element along the direction perpendicular to the central axis may be a circle or an ellipse.

In an embodiment, the terminal portion may be coupled to the one surface of the case by riveting.

In an embodiment, the terminal portion may have a placement space formed therein, and the variable resistance element may contact an inner surface of the placement space.

In an embodiment, the battery cell according to the present disclosure may further include an insulating member disposed between an inner surface of the through-hole and the terminal portion.

In an embodiment, the case may include a housing including an opening in the other surface facing the one surface of the case, and a cap assembly coupled to the housing and covering the opening.

In an embodiment, the case may have a cylindrical shape.

In an embodiment, the electrode assembly may include: a positive electrode, a negative electrode, and a separator separating the positive electrode and the negative electrode from each other and preventing or mitigating the case from contacting the positive electrode or the negative electrode; a first current collector having a disk shape and electrically connecting the positive electrode to the terminal portion; and a second current collector having a disk shape and electrically connecting the negative electrode to the case.

In an embodiment, an imaginary case axis passing through a center of the case may be aligned with a central axis of the through-hole.

A battery cell according to the present disclosure may include a case accommodating an electrode assembly therein, a through-hole penetrating through one surface of the case, a terminal portion electrically connected to the electrode assembly and protruding to an outside of the case through the through-hole, and a variable resistance element accommodated in the terminal portion, maintaining a resistance value greater than or equal to a first resistance value at room temperature, and maintaining a resistance value greater than or equal to a second resistance value, which is greater than the first resistance value, at a predetermined temperature higher than the room temperature.

First, according to an embodiment of the present disclosure, electrical characteristics of a battery cell may be improved.

Second, according to another embodiment of the present disclosure, thermal characteristics of the battery cell may be improved.

Third, according to still another embodiment of the present disclosure, a rapid flow of current in the battery cell may be minimized or reduced.

### BRIEF DESCRIPTION OF THE DRAWINGS

FIG. 1 illustrates an example of a battery cell according to the present disclosure;

FIG. 2 illustrates an example of an electrode assembly according to the present disclosure;

FIG. 3 illustrates a cross-section of a cap assembly according to the present disclosure;

FIG. 4 illustrates a cross-section of a terminal portion according to the present disclosure;

FIG. 5 illustrates an enlarged cross-section of a terminal portion according to the present disclosure; and

FIG. 6 illustrates various shapes of a terminal portion according to the present disclosure.

### DETAILED DESCRIPTION

Hereinafter, specific descriptions in accordance with the present disclosure are provided with reference to the accompanying drawings. It is noted, however, that the descriptions are merely illustrative and the present disclosure is not limited to specific embodiments described in this specification.

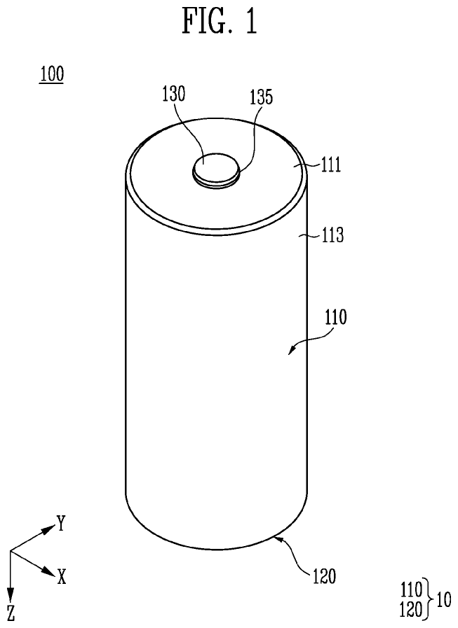

In the present disclosure, the terms “battery”, “secondary battery”, and “cell” are used interchangeably to refer to a battery cell capable of being charged and discharged. FIG. 1 illustrates an example of a battery cell according to the present disclosure.

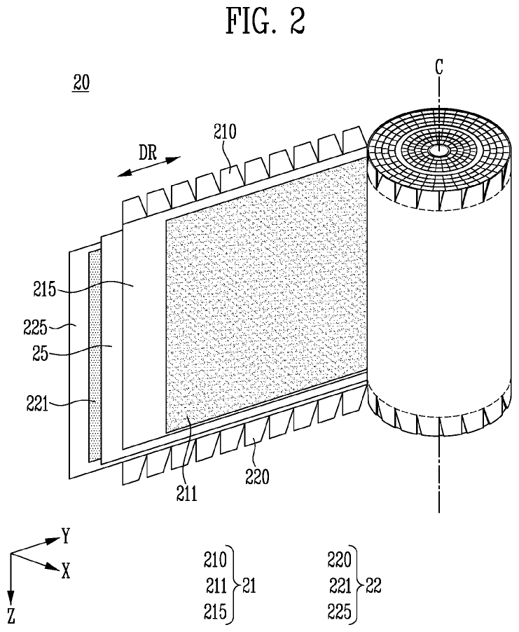

Referring to FIG. 1, a battery cell 100 according to the present disclosure may include a case 10 accommodating therein an electrode assembly (20, see FIG. 2) generating or storing electrical energy, and a terminal portion 130 electrically connected to the electrode assembly 20 and protruding to the outside of the case 10. The case 10 may have one of a cylindrical shape, a prismatic shape, and a pouch

shape depending on an external shape thereof. For example, the case 10 may have a cylindrical shape. FIG. 1 illustrates the cylindrical battery cell 100; however, the shape of the battery cell 100 in the present disclosure is not limited thereto.

In other words, the battery cell 100 according to the present disclosure may be applied not only to a cylindrical battery cell but also to battery cells of various other shapes.

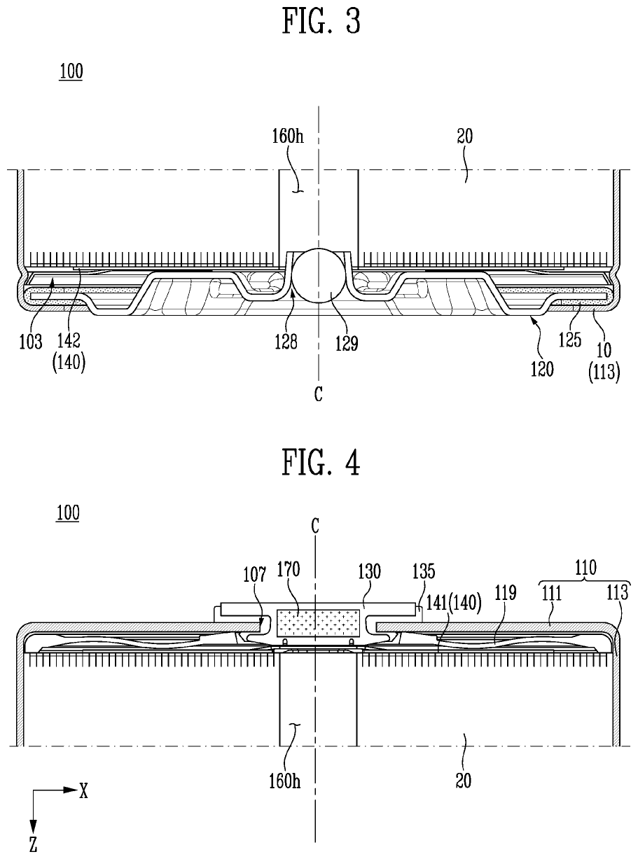

The case 10 may include a housing 110 including an opening (103, see FIG. 3) and accommodating the electrode assembly 20 through the opening 103, and a cap assembly 120 coupled to the housing 110 and covering the opening 103. When the housing 110 is in a cylindrical shape, the opening 103 may be provided in one surface, which is a top surface, or in the other surface, which is a bottom surface, of the housing 110 in a cylindrical shape.

Specifically, the case 10 may include the housing 110 including the opening 103 in the other surface facing one surface of the case 10, and the cap assembly 120 coupled to the housing 110 and covering the opening 103.

Referring to FIG. 1, the opening 103 may be located in a direction opposite to the terminal portion 130. That is, the terminal portion 130 and the cap assembly 120 may be spaced apart to face each other.

The housing 110 may be manufactured by deep drawing using a circular disk. One surface of the housing 110 may be closed, and the other surface facing the one surface of the housing 110 may include the opening 103. In other words, the housing 110 may include a side portion 113 extending from the one surface, which is closed, and forming a circumferential surface, and a planar portion 111 forming the one surface of the case 10. The other surface of the case 10 may be opened.

The terminal portion 130 may be provided in the opening 103 or the cap assembly 120 closing the opening 103. Alternatively, the terminal portion 130 may be located in the planar portion 111, which is the one surface of the case 10.

The battery cell 100 may further include a through-hole (107, see FIG. 4), penetrating through the planar portion 111, and the terminal portion 130 may be inserted into the through-hole 107. One side of the terminal portion 130 may be provided inside the case 10 through the through-hole 107, and the other side of the terminal portion 130 may be provided outside the case 10 through the through-hole 107.

The battery cell 100 may further include an insulating member 135 to electrically insulate the terminal portion 130 from the case 10. The terminal portion 130 is electrically connected to an electrode assembly provided inside the case 10, and by interposing the insulating member 135 between the terminal portion 130 and the case 10, the case 10 may be electrically insulated from the terminal portion 130. Accordingly, the case 10 and the terminal portion 130 may have different polarities. Specifically, the insulating member 135 may include a gasket.

FIG. 2 illustrates an example of an electrode assembly according to the present disclosure.

FIG. 2 is a partially exploded view of the wound electrode assembly 20. The electrode assembly 20 may include a positive electrode 21 (or first electrode), a negative electrode 22 (or second electrode), and a separator 25 separating the positive electrode 21 from the negative electrode 22.

The positive electrode 21 and the negative electrode 22 may have different electrical polarities. The positive electrode 21 may include a first plate 215 on which a positive electrode active material 211 is stacked, and a first flag 210 protruding along one direction from the first plate 215. The negative electrode 22 may include a second plate 225 on which a negative electrode active material 221 is stacked, and a second flag 220 protruding along one direction from the second plate 225 in a direction opposite to the direction in which the first flag 210 protrudes.

Each of the first plate 215, the second plate 225 and the separator 25 may be configured as a sheet extending in one direction. The positive electrode 21, the negative electrode 22, and one or more separators 25 interposed between the positive electrode 21 and negative electrode 22 may be stacked and/or wound to form the electrode assembly 20. The electrode assembly 20 may be wound about a central axis (or central axis C of the through-hole 107), and the first flag 210 and the second flag 220 may be provided on one side and the other side of the electrode assembly 20, respectively, and may protrude in opposite directions from each other. The first flag 210 may be formed by cutting an uncoated portion, on which the positive electrode active material 211 is not coated, from the first plate 215, and the second flag 220 may be formed by cutting an uncoated portion, on which the negative electrode active material 221 is not coated, from the second plate 225.

The first flag 210 may include a plurality of first flags 210 and the second flag 220 may include a plurality of second flags 220 along a winding direction DR. FIG. 2 illustrates an example of the plurality of first flags 210 and the plurality of second flags 220 before being bent. The plurality of first flags 210 may be bent toward the central axis of the electrode assembly 20. This is to bring the plurality of first flags 210 into contact with each other to increase an area of a current path. Similarly, the plurality of second flags 220 may be bent toward the central axis of the electrode assembly 20. The plurality of second flags 220 bent toward the central axis may come into contact with each other, thereby increasing the area of the current path.

The positive electrode active material 211 may include a metal oxide including lithium, sodium, potassium, a transition metal, or the like. Specifically, the positive electrode active material 211 may include at least one of a lithium transition metal oxide or a nickel-cobalt-manganese-based lithium oxide. The negative electrode active material 221 may include at least one of a carbon material, lithium, a lithium metal compound, silicon, a silicon compound, tin, or a tin compound.

The above-described embodiment is a mere example, and the positive electrode active material and the negative electrode active material may be modified and implemented without limitation as to type.

The separator 25 may be disposed between one surface of the positive electrode 21 and one surface of the negative electrode 22 facing each other. Furthermore, the separator 25 may also be disposed on the other surface of the negative electrode 22 to electrically insulate the electrode assembly 20 from the case 10. The separator 25 may include a polymeric gel or a porous polymer sheet.

In another aspect of the present disclosure, the separator 25 may be omitted. For example, when a solid electrolyte or the like is used, the solid electrolyte may be interposed between the positive electrode 21 and negative electrode 22 and the separator might not be used.

Referring to FIG. 2, the electrode assembly 20 may be formed by stacking the sheet-shaped positive electrode 21, the sheet-shaped negative electrode 22, and the sheet-shaped separator 25 and winding the same into a roll form. However, this is only an example, and the shape and the method of manufacturing the electrode assembly 20 are not limited thereto.

FIG. 3 illustrates a cross-section of a cap assembly according to the present disclosure.

More specifically, FIG. 3 illustrates a cross-section of a region adjacent to the cap assembly 120, which is a lower side of the secondary battery of FIG. 1.

As mentioned above, the electrode assembly 20 may be wound into a roll form. In this case, because the electrode assembly 20 has a curvature that increases in a direction toward the central axis C, the positive electrode 21 and the negative electrode 22 may be damaged. Therefore, the electrode assembly 20 may be wound so as to be spaced apart by a predetermined radius in a radial direction from the central axis C. That is, the electrode assembly 20 may include a central hole 160h in a region adjacent to the central axis C. This is to prevent or mitigate damage to the positive electrode 21 and the negative electrode 22 when the electrode assembly 20 is wound, and the central hole 160h may be formed in consideration of a degree of bending of the electrode assembly 20 (i.e., a curvature radius). The electrode assembly 20 may include an empty space having the predetermined radius from the central axis C, and the empty space may be the central hole 160h. At least a portion of the central hole 160h may be filled with an electrolyte solution when the electrolyte solution is injected through an injection hole 128.

For example, in the present disclosure, an imaginary central axis of the injection hole 128 and the imaginary central axis C of the through-hole 107 may be the same.

Furthermore, when the case 10 is in a cylindrical shape, an imaginary central axis of the roll-shaped electrode assembly 20 and a case axis, which is an imaginary central axis passing through the center of the cylindrical case 10, may coincide. Thus, the case axis may be aligned with the central axis C of the through-hole 107.

The electrode assembly 20 may further include a current collector 140. The current collector 140 may include a first current collector (141, see FIG. 4) electrically connecting the positive electrode 21 to the terminal portion 130, and a second current collector 142 electrically connecting the negative electrode 22 to the housing 110 or the cap assembly 120.

In other words, the electrode assembly 20 may further include the positive electrode 21, the negative electrode 22, and the separator 25 separating the positive electrode 21 and the negative electrode 22 from each other and preventing or mitigating the case 10 from contacting the positive electrode 21 or the negative electrode 22, the first current collector 141 having a disk shape and electrically connecting the positive electrode 21 to the terminal portion 130, and the second current collector 142 having a disk shape and electrically connecting the negative electrode 22 to the case 10.

The first current collector 141 and the second current collector 142 may each include a conductive material, and may have a size corresponding to a top surface or a bottom surface of the electrode assembly 20. The first current collector 141 and the second current collector 142 may be coupled to the first flag 210 and the second flag 220, respectively, by welding.

The first current collector 141 may be disposed to face the planar portion 111 or the one surface of the case 10 along the central axis C, and the second current collector 142 may be disposed to face the cap assembly 120.

Further, the battery cell 100 may further include a buffer member 125 for electrically insulating the cap assembly 120 from the case 10. The buffer member 125 may include an insulating material including a polymer or the like.

The cap assembly 120 may have a disk shape centered on the central axis C. Further, the cap assembly 120 may include the injection hole 128 penetrating through the cap assembly 120 along the central axis C.

The injection hole 128 may be used when injecting an electrolyte solution into the case 10. The battery cell 100 may further include a spherical closing portion 129 configured to close the injection hole 128 after the electrolyte solution is injected.

The electrolyte solution may be injected through the injection hole 128 after the cap assembly 120 is coupled to the case 10, and before the injection hole 128 is closed. Alternatively, however, the electrolyte solution may be injected into the case 10 through the opening 103 before the cap assembly 120 is coupled thereto.

FIG. 4 illustrates a cross-section of a terminal portion according to the present disclosure.

More specifically, FIG. 4 illustrates a cross-section of a region adjacent to the planar portion 111, which is an upper side of the secondary cell of FIG. 1, or the one surface of the case 10.

The battery cell 100 according to the present disclosure may include the case 10 accommodating the electrode assembly 20 therein, the through-hole 107 penetrating through the one surface of the case 10, the terminal portion 130 electrically connected to the electrode assembly 20 and protruding to the outside of the case 10 through the through-hole 107, and a variable resistance element 170 accommodated in the terminal portion 130 and having resistance that varies according to temperature.

As described above, the case 10 may include the housing 110 and the cap assembly (120, see FIG. 3). Further, the housing 110 may include the planar portion 111 forming the one surface of the case 10 and the side portion 113 forming a side surface of the case 10.

The through-hole 107 may have a circular shape. Accordingly, the terminal portion 130 may also have a cylindrical shape. When the through-hole 107 penetrates through the one surface of the cylindrical case 10, the through-hole 107 may be located at the center of the case 10. Accordingly, the imaginary central axis C passing through the center of the through-hole 107 and the imaginary case axis (not shown) passing through the center of the case 10 may be coaxial.

Similarly, a central axis of the central hole 160h may coincide with the central axis C of the through-hole 107 and the case axis.

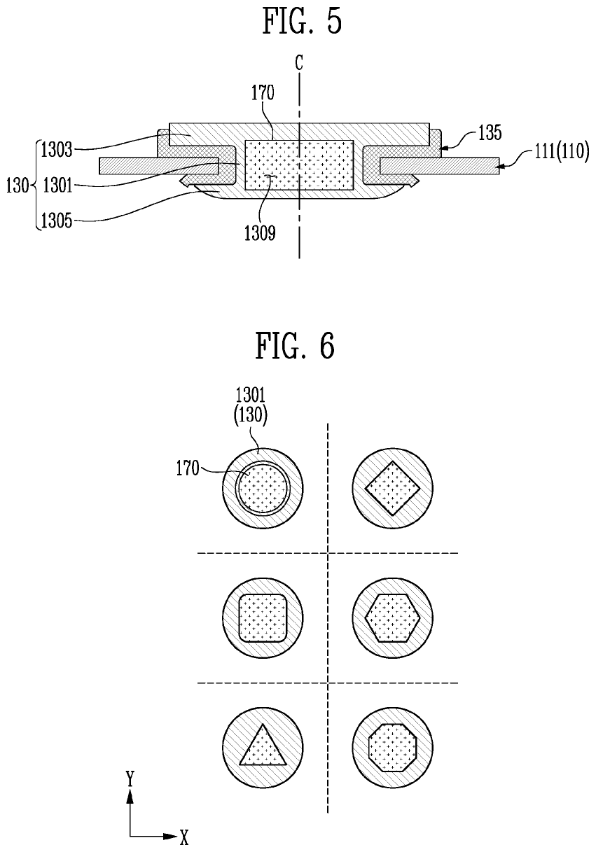

The variable resistance element 170 may be inserted into the terminal portion 130. That is, the terminal portion 130 may include a hollow placement space (1309, see FIG. 5), and the variable resistance element 170 may be accommodated in the placement space 1309.

The terminal portion 130 may have the placement space 1309 formed therein, and the variable resistance element 170 may contact an inner surface of the placement space 1309.

Accordingly, during normal operation, the variable resistance element 170 may serve as a passage through which a current flows.

When the temperature of the terminal portion 130 rises due to an unintended rapid flow of current, such as an external short circuit, a resistance value of the variable resistance element 170 may rise rapidly, and thus the flow of current may be minimized, reduced or interrupted. Thus, the variable resistance element 170 may improve the stability of the battery cell 100.

To this end, the variable resistance element 170 may include a material having Positive Temperature Coefficient (PTC) characteristics at or above a first temperature.

The material having the PTC characteristics may refer to a material of which a resistance value changes rapidly according to temperature. For example, while the resistance value of the variable resistance element 170 is low enough to exhibit conductivity at room temperature, the resistance value of the variable resistance element 170 may increase rapidly at or above the first temperature higher than the room temperature, thereby decreasing the conductivity.

For example, the material having the PTC characteristics may be a polymer material including an electrically conductive filler. That is, the polymer material is generally recognized as materials having excellent insulating properties, but when a filler such as carbon black (CB), carbon fiber, metal powder, or the like is added to the polymer material, the polymer material may exhibit electrical conductivity. The filler forms an electrical path within the polymer material and thus serves as a passage for movement of electrons.

When the temperature of the polymer material increases, the distance between the fillers within the polymer may increase due to thermal expansion in a melting region of the polymer. The increase in the distance between the fillers may hinder the flow of current. Thus, the material having the PTC characteristics exhibits a phenomenon in which resistance abruptly and significantly increases as temperature increases, which is referred to as a PTC phenomenon, and a material utilizing this principle may be referred to as a material having PTC characteristics. Specifically, the variable resistance element 170 may include a PTC element.

The first temperature may be from 60° C. to less than 200° C. The variable resistance element 170 may undergo a change in crystal structure or state thereof at or above the first temperature. As the crystal structure or state changes at or above the first temperature, a charge transfer path may be altered, thereby causing the resistance to increase sharply.

Specifically, the first temperature may be from 60° C. to 180° C., from 60° C. to 150° C., from 60° C. to 130° C., from 60° C. to 110° C., from 80° C. to 180° C., from 80° C. to 150° C., from 80° C. to 120° C., from 110° C. to 180° C., from 110° C. to 160° C., from 110° C. to 140° C., from 110° C. to 130° C., or from 120° C. to 130° C.

Accordingly, the battery cell 100 according to the present disclosure may include the case 10 accommodating the electrode assembly 20 therein, the through-hole 107 penetrating through the one surface of the case 10, the terminal portion 130 electrically connected to the electrode assembly 20 and protruding to the outside of the case 10 through the through-hole 107, and the variable resistance element 170 accommodated in the terminal portion 130, maintaining a resistance value greater than or equal to a first resistance value at room temperature, and maintaining a resistance value greater than or equal to a second resistance value, which is greater than the first resistance value, at the predetermined temperature higher than the room temperature.

The first resistance value of the variable resistance element 170 may refer to a resistance value when a direct current is applied to the variable resistance element 170 at 25° C. (degrees Celsius). The second resistance value of the variable resistance element 170 may refer to a resistance value when a direct current is applied to the variable resistance element 170 at 200° C. The variable resistance element 170 may maintain the second resistance value at a level higher than the first resistance value, thereby improving the safety of the battery cell 100.

Specifically, the first resistance value may be less than or equal to 100 μOhm, and the second resistance value may be greater than or equal to 80 mOhm. More specifically, the first resistance value may be less than or equal to 80 μOhm, less than or equal to 60 μOhm, less than or equal to 40 Ohm, or less than or equal to 20 μOhm. More specifically, the first resistance value may be from 0.005 μOhm to 40 μOhm,

Further, the second resistance value may be greater than or equal to 85 mOhm, greater than or equal to 90 mOhm, greater than or equal to 95 mOhm, or greater than or equal to 100 mOhm. More specifically, the second resistance value may be from 100 mOhm to 10000 mOhm.

The battery cell 100 according to the present disclosure may further include the insulating member 135 disposed between an inner surface of the through-hole 107 and the terminal portion 130. The insulating member 135 may not only provide electrical insulation, but also seal the through-hole 107. The insulating member 135 may have a ring shape surrounding a periphery of the terminal portion 130 and contacting the inner surface of the through-hole 107.

Further, for electrical insulation between the one surface of the case 10 and the first current collector 141, the battery cell 100 may further include an insulating cover 119 between the one surface of the case 10 and the current collector 141. Through the insulating cover 119, the positive electrode 21 may be electrically isolated from the planar portion 111 and the side portion 113.

FIG. 5 illustrates an enlarged cross-section of a terminal portion according to the present disclosure.

In an embodiment, the terminal portion 130 may be coupled to the one surface of the case 10 by riveting. Accordingly, the insulating member 135 may seal a space between the terminal portion 130 and the one surface of the case 10 or the planar portion 111 while being compressed by the terminal portion 130. The insulating member 135 may include a gasket including an insulating material.

The terminal portion 130 may include a head portion 1303, in which an area of a cross-section of the terminal portion 130 taken along a direction perpendicular to the central axis C is greater than an area of the through-hole 107, a tail portion 1305 inserted into the case 10 and contacting the case 10, and a body portion 1301 connecting the head portion 1303 to the tail portion 1305 along the central axis C via the through-hole 107. At least a portion of the variable resistance element 170 may be accommodated in the body portion 1301.

At least a portion of the variable resistance element 170 may be accommodated inside the body portion 1301. That is, at least a portion of the placement space 1309 may be formed by the body portion 1301.

The central axis C of the through-hole 107 may extend in a direction passing through the variable resistance element 170. Thus, the variable resistance element 170 may have a cylindrical shape about the central axis C.

An average length of the variable resistance element 170, which is a length along a direction parallel to the imaginary central axis C passing through the center of the through-hole 107, may be greater than or equal to 1 mm and less than or equal to 4 mm. When the average length of the variable resistance element 170 (in the Z-direction) is less than 1 mm, the variable resistance element 170 may fail to detect a sudden flow of current, which is problematic, and when the average length exceeds 4 mm, the resistance of the terminal portion 130 may increase significantly, thereby impeding current flow at room temperature.

An average cross-sectional area of the variable resistance element 170, taken along a direction perpendicular to the central axis C, may be greater than or equal to 50% and less than or equal to 90% of an average cross-sectional area of the body portion 1301. When the average cross-sectional area of the variable resistance element 170 is less than 50% of that of the body portion 1301, it may be difficult for the variable resistance element 170 to detect a sudden current flow, and when the average cross-sectional area exceeds 90%, the room-temperature resistance of the terminal portion 130 may increase, which is problematic.

When the variable resistance element 170 according to an embodiment of the present disclosure is provided within the terminal portion 130, and has a size within the aforementioned range, so as not to impede the current flow of the terminal portion 130 under normal conditions, the current flow may be effectively reduced or interrupted when an abnormal condition, such as a sudden current flow, occurs.

FIG. 6 illustrates various shapes of a terminal portion according to the present disclosure.

Referring to FIGS. 5 and 6, the variable resistance element 170 may have a pillar shape extending along the central axis C. For example, the placement space 1309 in which the variable resistance element 170 is disposed may have the center through which the central axis C passes.

The shape of the variable resistance element 170 may be varied, as long as the variable resistance element 170 satisfies a thickness or area ratio within the aforementioned range.

As shown in FIG. 6, the cross-section of the variable resistance element 170 may have various shapes. Further, the placement space 1309 may be configured to correspond to the shape of the variable resistance element 170. Specifically, the shape of the cross-section of the variable resistance element 170 may include one or more of a circle, an ellipse, a triangle, a rectangle, a hexagon, and an octagon. For example, the shape of the cross-section of the variable resistance element 170 along the direction perpendicular to the central axis C may be a circle or an ellipse. Alternatively, the shape of the cross-section of the variable resistance element 170 along the direction perpendicular to the central axis C may be a polygon. Furthermore, corners of the variable resistance element 170 having a polygonal shape may be rounded.

Hereinafter, embodiments of the present disclosure will be further described with reference to specific experimental examples. Examples and Comparative Examples included in the experimental examples are merely illustrative of the present disclosure and are not intended to limit the scope of the appended claims, and it will be apparent to those skilled in the art that various changes and modifications can be made to the Examples within the scope and spirit of the present disclosure, and it is natural that such changes and modifications fall within the scope of the appended claims.

Using the variable resistance element 170 according to embodiments described above with reference to FIGS. 1 to 6, a first resistance value and a second resistance value were measured for a material having PTC characteristics, which is the variable resistance element 170, with varying thicknesses and areas, as described below. In the Examples and Comparative Examples, the variable resistance element 170 was uniformly configured in a cylindrical shape with a circular cross-section, the first resistance value and the second resistance value were measured using a resistance meter (Model RM3548, HIOKI) while varying the thickness of the variable resistance element 170, and the results are shown in Table 1. In addition, with the thickness of the variable resistance element 170 kept constant, the first resistance value and the second resistance value were measured using the resistance meter (Model RM3548, HIOKI) while varying the area ratio, and the results are shown in Table 2. In Table 1 and Table 2, the PTC thickness corresponds to the length of the variable resistance element 170 in the Z-direction, and the PTC area ratio refers to the ratio of the area of the cross-section of the variable resistance element 170 to that of the body portion 1301 of the terminal portion 130 as described above. The first resistance value and the second resistance value were determined by measuring a voltage while applying a 1 A current to the secondary batteries having variable resistance elements 170 according to the Examples and Comparative Examples. Specifically, the second resistance value was determined by measuring the resistance at 200° C. for the corresponding component, which had reached thermal equilibrium after being maintained in a chamber at 200° C. for 10 minutes.

TABLE 1

| Example or | PTC | PTC Area | First | Second |
|---|---|---|---|---|
| Comparative | Thickness | Ratio | Resistance | Resistance |
| Example | (mm) | (%) | Value (μOhm) | Value (mOhm) |
| Example 1 | 1 | 70 | 12.4 | 141 |
| Example 2 | 3 | 70 | 16.6 | 237 |
| Example 3 | 4 | 70 | 19.6 | 1365 |
| Comparative | 0.5 | 70 | 11.8 | 61 |
| Example 1 | | | | |
| Comparative | 5 | 70 | 123.2 | 2234 |
| Example 2 | | | | |

Table 1 above shows the experimental results obtained by varying the length or thickness of the variable resistance element 170 while keeping the area ratio constant, which is the ratio of the area of the variable resistance element 170 to the area of the body portion 1301 taken along the cross-section perpendicular to the central axis C. 5

Referring to Examples 1 to 3 and Comparative Examples 1 and 2, the first resistance value of the variable resistance element 170 refers to a resistance value when a direct current is applied to the variable resistance element 170 at 25° C. (degrees Celsius). The second resistance value of the variable resistance element 170 refers to a resistance value when a direct current is applied to the variable resistance element 170 at a temperature of 200° C.

Compared to Comparative Example 1 and Comparative Example 2 above, it can be seen that the second resistance values of the variable resistance element 170 in Examples 1 to 3 above are neither excessively high nor excessively low.

This is because when the second resistance value is too high, the temperature of the terminal portion 130 and the variable resistance element 170 may rise sharply, leading to deformation or damage, and when the second resistance value is too low, the variable resistance element 170 might not be able to minimize, reduce, or interrupt excessive current.

In particular, in Comparative Example 1, the second resistance value at 200° C. is low, making it difficult to serve as a resistor, and in Comparative Example 2, the first resistance value at 25° C. exceeds 100 μOhm, which may adversely affect the battery output due to a significant increase in the component resistance.

Therefore, referring to Table 1 above, the length of the variable resistance element 170 along the imaginary central axis C passing through the center of the through-hole 107 may be greater than or equal to 1 mm and less than or equal to 4 mm.

TABLE 2

| | Variable | Variable | First | Second |
|---|---|---|---|---|
| Example or | Resistance | Resistance | Resistance | Resistance |
| Comparative | Element | Element Area | Value | Value |
| Example | Thickness (mm) | Ratio (%) | (μOhm) | (mOhm) |
| Example 4 | 2 | 70 | 15.2 | 176 |
| Example 5 | 2 | 50 | 10.6 | 89 |
| Example 6 | 2 | 90 | 29.4 | 1213 |
| Comparative | 2 | 30 | 7.4 | 0.23 |
| Example 3 | | | | |
| Comparative | 2 | 95 | 137.0 | 9442 |
| Example 4 | | | | |

Table 2 above shows the first resistance value and the second resistance value of the variable resistance element 170 obtained by varying the area ratio, which is the ratio of the area of the variable resistance element 170 to the area of the body portion 1301 taken along the cross-section perpendicular to the central axis C while keeping the length or thickness of the variable resistance element 170 along the central axis C constant.

Compared to Comparative Examples 3 and 4, it can be seen that there is an area ratio of the variable resistance element 170 in which the second resistance value of the variable resistance element 170 falls within an appropriate range in Examples 4 to 6. That is, referring to Table 2 above, the area of the cross-section of the variable resistance element 170 taken along the direction perpendicular to the central axis C may be greater than or equal to 50% and less than or equal to 90% of that of the body portion 1301.

In particular, in Comparative Example 3, the second resistance value at 200° C. is low, making it difficult to serve as a resistor, and in Comparative Example 4, the first resistance value at 25° C. exceeds 100 μOhm, which may adversely affect the battery output due to a significant increase in the component resistance.

The descriptions as set forth above are merely examples to which the principles of the present disclosure are applied, and other configurations may be further included without departing from the scope of the present disclosure.

What is claimed is:

1. A battery cell comprising:
a case accommodating an electrode assembly therein;
a through-hole penetrating through one surface of the case;
a terminal portion electrically connected to the electrode assembly and protruding to an outside of the case through the through-hole; and
a variable resistance element accommodated in the terminal portion and having resistance that varies according to temperature.

2. The battery cell of claim 1, wherein the variable resistance element includes a material having Positive Temperature Coefficient (PTC) characteristics at or above a first temperature.

3. The battery cell of claim 1, wherein an average length of the variable resistance element along a direction parallel to an imaginary central axis passing through a center of the through-hole is greater than or equal to 1 mm and less than or equal to 4 mm.

4. The battery cell of claim 3, wherein the terminal portion comprises:
a head portion in which an area of a cross-section of the terminal portion taken along a direction perpendicular to the central axis is greater than an area of the through-hole;
a tail portion inserted into the case and contacting the case; and
a body portion connecting the head portion to the tail portion along the central axis via the through-hole, and
wherein at least a portion of the variable resistance element is accommodated in the body portion.

5. The battery cell of claim 4, wherein an average cross-sectional area of the variable resistance element, taken along the direction perpendicular to the central axis, is greater than or equal to 50% and less than or equal to 90% of an average cross-sectional area of the body portion.

6. The battery cell of claim 5, wherein a shape of a cross-section of the variable resistance element along the direction perpendicular to the central axis is a polygon.

7. The battery cell of claim 5, wherein a shape of a cross-section of the variable resistance element along the direction perpendicular to the central axis is a circle or an ellipse.

8. The battery cell of claim 1, wherein the terminal portion is coupled to the one surface of the case by riveting.

9. The battery cell of claim 8, wherein the terminal portion has a placement space formed therein, and
wherein the variable resistance element contacts an inner surface of the placement space.

10. The battery cell of claim 1, further comprising an insulating member disposed between an inner surface of the through-hole and the terminal portion.

11. The battery cell of claim 1, wherein the case comprises:
a housing including an opening in the other surface facing the one surface of the case; and
a cap assembly coupled to the housing and covering the opening.

12. The battery cell of claim 1, wherein the case has a cylindrical shape.

13. The battery cell of claim 12, wherein the electrode assembly comprises:
a positive electrode, a negative electrode, and a separator separating the positive electrode and the negative electrode from each other and preventing or mitigating the case from contacting the positive electrode or the negative electrode;
a first current collector having a disk shape and electrically connecting the positive electrode to the terminal portion; and
a second current collector having a disk shape and electrically connecting the negative electrode to the case.

14. The battery cell of claim 12, wherein an imaginary case axis passing through a center of the case is aligned with a central axis of the through-hole.

15. A battery cell comprising:
a case accommodating an electrode assembly therein;
a through-hole penetrating through one surface of the case;
a terminal portion electrically connected to the electrode assembly and protruding to an outside of the case through the through-hole; and
a variable resistance element accommodated in the terminal portion, maintaining a resistance value greater than or equal to a first resistance value at room temperature, and maintaining a resistance value greater than or equal to a second resistance value, which is greater than the first resistance value, at a predetermined temperature higher than the room temperature.
